(19) United States
(12) Patent Application Publication
(10) Pub. No.: US 2021/0363975 A1
(43) Pub. Date: Nov. 25, 2021

(54) METHOD FOR DETECTING LIGHTNING STRIKES IN A WIND TURBINE ROTOR BLADE AND LIGHTNING STRIKE MEASUREMENT SYSTEM

(71) Applicant: Wobben Properties GmbH, Aurich (DE)

(72) Inventor: Alexander HOFFMANN, Emden (DE)

(21) Appl. No.: 16/957,263

(22) PCT Filed: Jan. 10, 2019
(86) PCT No.: PCT/EP2019/050497

§ 371 Date: Jun. 23, 2020

(30) Foreign Application Priority Data
Jan. 11, 2018 (DE) 10 2018 100 492.3

(51) Int. Cl. F03D 80/30; F03D 17/00

(52) U.S. Cl. CPC F03D 80/30; F05B 2270/8041; F05B 2270/3032; F03D 17/00

(57) ABSTRACT

There is provided a method of detecting lightning strikes in a wind turbine rotor blade. The wind turbine rotor blade has a lightning protection system. A digital camera or an optical-digital heat sensor is provided in the region of a rotor blade root, in a hub of the wind turbine or in or on a tower of the wind turbine in such a way that the digital camera at least partially optically detects a part of the lightning protection system. The part of the lightning protection system is optically detected by the camera to carry out optical temperature detection. An increase in temperature of the part of the lightning protection system is detected based on the optical detection by the camera.

### BACKGROUND

### Technical Field

The present invention concerns a method of detecting lightning strikes in a wind turbine rotor blade and lightning strike measurement system.

### Description of the Related Art

By virtue of the height of wind turbines, they can be relatively frequently hit by a lightning strike. As the rotor blades typically represent the highest point of the wind turbine, the rotor blades are particularly at risk. Typically therefore a lightning protection system is provided in the wind turbine. A lightning receptor can be provided at the rotor blade tip and is preferably connected to an electrically conductive lightning dissipation system within the rotor blade. When a wind turbine is hit by lightning that can lead to considerable damage in particular at the rotor blades.

On the German patent application from which priority is claimed the German Patent and Trade Mark Office searched the following documents: EP 2 466 321 A1 and WO 2009/083 006 A1.

### BRIEF SUMMARY

Provided is a measurement system and a method of detecting lightning strikes in wind turbine rotor blades.

In particular, provided is a method of detecting lightning strikes in a wind turbine rotor blade. The wind turbine rotor blade has a lightning protection system. A digital camera or an optical-digital heat sensor is provided in the region of a rotor blade root, in the proximity of the wind turbine or in or on a tower of the wind turbine in such a way that the digital camera or the digital heat sensor at least partially optically detects a part of the lightning protection system. The part of the lightning protection system is optically detected by the camera to carry out optical temperature detection. An increase in temperature of the part of the lightning protection system is detected based on the optical detection by the camera. In that way a lightning strike can be contact-lessly detected by optical monitoring of the lightning protection system in the rotor blade.

According to an aspect of the present invention a message can be output if lightning has struck the wind turbine rotor blade. That can be effected in dependence on the optically detected increase in temperature.

According to an aspect of the present invention the lightning protection system has at least one lightning protection conductor system and a lightning protection connection point. The camera or the heat sensor is provided stationarily in the region of a rotor blade root of the rotor blade or in a hub of the wind turbine in such a way that the camera or the heat sensor at least partially optically detects a portion of the electrically conductive lightning protection conductor system or the lightning protection connection point and thus optical temperature measurement can be carried out.

According to an aspect of the present invention the temperature of the material of the rotor blade is detected and compared to the temperature of the electrically conductive lightning protection conductor system and/or the lightning connection point. A message is output if the temperature difference between the temperature of the electrically conductive conductor system and the material of the rotor blade exceeds a limit value.

According to a further aspect of the present invention classification of the detected lightning strikes can be effected based on the detected increase in temperature.

According to an aspect of the present invention a digital camera or an optical-digital heat sensor (for example AMG8833 by Panasonic) is placed in or on the wind turbine rotor blade and for example a lightning protection conductor or a lightning protection cable is set up on at least a part of the lightning protection system, in particular on an electrically conductive lightning conductor system. The camera can thus be disposed in the interior of the rotor blade or in the region of the hub of the wind turbine and monitors the hollow space or internal volume of the rotor blade. As an alternative thereto the camera can be provided externally on the rotor blade or the hub of the wind turbine to monitor a part of the lightning protection system which is disposed externally on the rotor blade.

The digital camera should be capable of detecting in particular IR (infrared) radiation. The digital camera can have a CCD (charge coupled device) sensor for optical detection. As an alternative thereto it is possible to provide an optical-digital heat sensor for optical temperature detection. If lightning strikes the rotor blade then the electrically conductive lightning conductor system, lightning protection cable or lightning protection conductor will considerably heat up, more specifically markedly more than the surrounding material of the rotor blade. That increase in temperature of the rotor blade can be detected by the camera. If a lightning strike has been detected by the measurement system then a corresponding signal can be communicated to the service personnel to investigate the damage to the wind turbine and in particular the damage to the rotor blade.

According to an aspect of the present invention the lightning protection system has a lightning conductor system and a lightning protection connection point. In addition a dissipator ring in the region of the rotor blade root can be part of the lightning protection system. The camera is directed on to a part of the lightning protection system to carry out optical temperature detection. Preferably the camera is directed on to a part of the lightning protection system which is not covered by another material but is exposed to permit effective optical temperature detection.

According to an aspect of the present invention the camera or the heat sensor is provided stationarily in or on the rotor blade. Accordingly the camera rotates when the pitch angle of the rotor blade is changed. That can ensure that the camera always optically monitors a part of the lightning protection system.

According to an aspect of the present invention a limit value of a temperature difference for example in relation to the surrounding material or a time-dependent mean value of a plurality of measurements, as from which a message is output, can be greater than 5° C. In particular the limit value can be greater than 20° C. or 30° C.

According to an aspect of the present invention the wind turbine can be switched off or run down when a lightning strike is detected. It is only after service personnel have closely inspected the wind turbine or the rotor blade that the wind turbine can be started up again.

According to an aspect of the present invention the camera is preferably provided at a minimum spacing relative to the electrically conductive lightning conductor system to avoid electrical flashovers in the event of a lightning strike. The spacing between the camera and the electrically conductive lightning conductor system is preferably >1 m.

As the lightning strike measurement system with the camera is not electrically connected to the lightning protection system a lightning strike in the lightning protection system cannot result in the lightning strike measurement system being destroyed. That entails a considerable improvement in operational reliability of the lightning strike measurement system.

The digital camera or the optical-digital heat sensor represent an optical temperature detection unit for optimum temperature detection.

Further configurations of the invention are subject-matter of the appendant claims.

### BRIEF DESCRIPTION OF THE SEVERAL VIEWS OF THE DRAWINGS

Advantages and embodiments by way of example of the invention are described in greater detail hereinafter with reference to the drawing.

FIG. 1 shows a diagrammatic view of a wind turbine according to the invention, and

FIG. 2 shows a diagrammatic view of a wind turbine rotor blade with a measurement system.

### DETAILED DESCRIPTION

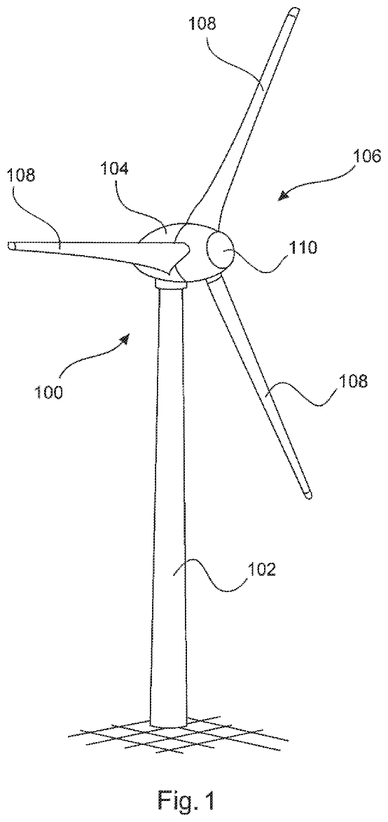

FIG. 1 shows a diagrammatic view of a wind turbine according to the invention.

FIG. 1 shows a wind turbine 100 having a tower 102 and a nacelle 104. Arranged on the nacelle 104 is a rotor 106 having three rotor blades 108 and a spinner 110. The rotor 106 is driven in rotation by the wind in operation and thereby drives a generator in the nacelle 104.

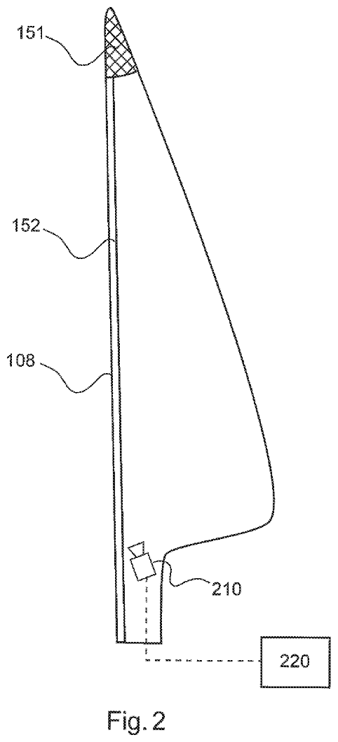

FIG. 2 shows a diagrammatic view of a wind turbine rotor blade with a measurement system. The rotor blade 108 has a lightning protection system 150, which for example has a lightning protection receptor 151 in the region of the rotor blade tip and an electrically conductive lightning conductor system 152 (for example in the form of a lightning protection cable) extending from the rotor blade tip to the rotor blade root. An optical temperature detection unit, for example a digital camera 210, is provided in the region of the rotor blade root or in the region of the hub of the wind turbine. The digital camera 210 is preferably at least partially directed on to a part of the lightning protection system, in particular the electrically conductive lightning conductor system 152 (for example in the form of a lightning protection cable). Alternatively or in addition to the digital camera it is possible to provide an optical-digital heat sensor as the optical temperature detection unit.

The digital camera 210 is coupled to an processor 220. The digital camera 210 thus performs digital detection of the electrically conductive lightning conductor system 152 and the material therearound of the rotor blade. When lightning strikes the lightning protection system that will lead to a considerable increase in temperature of the electrically conductive lightning conductor system 152. That increase in temperature is detected by the camera 210 and can be output to the processor 220. The measurement system (camera 210+processor 220) can detect the temperature of the electrically conductive lightning conductor system 152 and/or the temperature of the material therearound of the rotor blade 108. The processor 220 in accordance with an aspect of the present invention can carry out a comparison between the temperature of the electrically conductive lightning conductor system 152 and the temperature of the surrounding material. For example the processor 220 can compare the temperature of the electrically conductive lightning conductor system 152 and the material of the rotor blade. If the difference is too great it can be deduced therefrom that lightning has struck the lightning conductor system. The measurement can also be implemented by cyclic or time-sliding averaging of the detected temperature data.

Therefore optical temperature detection of a lightning protection system in a wind turbine rotor blade 108 is thus effected. The camera required for that purpose is disposed in the interior of the rotor blade 108 or in the region of the hub of the wind turbine and thus detects the temperature in the hollow interior of the wind turbine rotor blade.

According to an aspect of the present invention the rotor blade is composed of two shell portions (an upper shell and a lower shell).

The camera can be in the form of a thermal imaging camera.

The camera can create a video of the part to be monitored of the lightning protection system. Alternatively the camera can take photographs of the part of the lightning protection system at regular intervals. Those intervals can represent for example between one image per second and one image per minute.

According to an aspect of the present invention the camera can be part of or a combination of a mobile telephone or smartphone. The mobile telephone or smartphone can optically monitor the part of the lightning protection system and evaluate the detected photographs or videos and output a signal when a temperature difference is detected. Processing of the detected photographs or videos can be effected in the smartphone or mobile telephone or the camera. The signal can then be in the form of an SMS or over the Internet.

As an alternative thereto evaluation of the images or videos can be effected in an installation control arrangement of the wind turbine.

The output signal or warning can then be used to stop the wind turbine if a lightning strike has been detected. Restarting of the wind turbine can also be blocked until service personnel have checked the rotor blade after the lightning strike.

A part of the lightning protection system is optically detected. That can involve an exposed portion of the lightning conductor system (like for example a lightning protection cable), a part of an exposed electrically conductive conductor system, an exposed portion of the connecting points or a dissipator ring at the rotor blade root.

The camera can be arranged at a safety distance of greater than 1 meter relative to the part of the lightning protection system.

According to an aspect of the present invention the camera is in the form of a digital camera and has a CCD sensor or an optical-digital heat sensor.

According to a further aspect of the present invention classification of the lightning intensity of the detected lightning strikes can be effected based on the detected temperature measurements. By way of example a first lightning intensity can be detected with an increase in temperature of up to 15° C. A second lightning intensity can be detected when the temperature difference is between 15 and 25° C. A third lightning intensity can be detected with a temperature difference of greater than 25° C.

According to a further aspect of the present invention the digital camera can be placed in the tower, on the tower or at the tower base. That is particularly advantageous because that can provide a lightning strike measurement system, which is easily accessible and can also be subsequently installed.

The optical-digital heat sensor can represent for example a sensor AMG8833 from Panasonic. The heat sensor can have for example a multiplicity of measurement points. That multiplicity can be less than the usual number of sensors in a digital camera.

1. A method of detecting lightning strikes in a wind turbine rotor blade, wherein the wind turbine rotor blade has a lightning protection system, the method comprising:
arranging a digital camera or an optical-digital heat sensor in a region of a rotor blade root, a hub of the wind turbine, or a tower of the wind turbine so that the digital camera or the optical-digital heat sensor at least partially optically detects a part of the lightning protection system,
optically detecting a part of the lightning protection system by the digital camera or by the optical-digital heat sensor for optical temperature measurement; and
detecting an increase in temperature of the part of the lightning protection system based on the optical temperature measurement by the digital camera or the optical-digital heat sensor.

2. The method according to claim 1 further comprising:
outputting a message that lightning has struck the wind turbine rotor blade in dependence on the detected increase in temperature.

3. The method according to claim 1, wherein:
the lightning protection system has at least one lightning protection conductor system and a lightning protection connection point, and
wherein the digital camera or the optical-digital heat sensor is arranged in such a way that the digital camera or the optical-digital heat sensor at least partially optically detects a portion of the electrically conductive lightning protection conductor system, the lightning protection connection point or both.

4. The method according to claim 1, comprising:
detecting a temperature of a material of the rotor blade;
comparing the temperature of the rotor blade material and the optical temperature measurement of the part of the electrically conductive lightning protection conductor system, the lightning protection connection point; or both to obtain a temperature difference; and
outputting a message if the temperature difference between the temperature of the electrically conductive conductor system and the material of the rotor blade exceeds a threshold limit value.

5. The method according to claim 1 further comprising:
classifying the detected lightning strikes based on the detected increases in temperature.

6. A lightning strike measurement system for a wind turbine, comprising:
a digital camera or an optical-digital heat sensor; and
a processor configured to receive and evaluate data from the optical data of the digital camera or the optical-digital heat sensor,
wherein the processor is configured, based on the optical data of the digital camera or the optical-digital heat sensor, to carry out optical temperature measurement and to output a message if an optically measured temperature of a part of a lightning protection system exceeds a threshold limit value.

7. A wind turbine, comprising:
at least one rotor blade; and
at least one lightning strike measurement system for the wind turbine according to claim 6.

8. The wind turbine according to claim 7, comprising a hub and a tower, wherein the digital camera or the optical-digital heat sensor is arranged on a rotor blade root of the at least one rotor blade, a hub of the wind turbine, or a tower of the wind turbine.
